(19) United States
(12) Patent Application Publication
(10) Pub. No.: US 2014/0103028 A1
(43) Pub. Date: Apr. 17, 2014

(54) ELECTRIC HEATER AND METHOD FOR MANUFACTURING SUCH AN ELECTRIC HEATER

(71) Applicant: TURK & HILLINGER GMBH, Tuttlingen (DE)

(72) Inventor: Andreas SCHLIPF, Tuttlingen (DE)

(73) Assignee: TURK & HILLINGER GMBH, Tuttlingen (DE)

(21) Appl. No.: 14/051,882

(22) Filed: Oct. 11, 2013

(30) Foreign Application Priority Data
Oct. 12, 2012 (DE) 10 2012 109 740.2

(51) Int. Cl. H05B 3/44; H01C 17/02

(52) U.S. Cl. CPC H05B 3/44; H01C 17/02
USPC 219/534; 219/536; 29/611

(57) ABSTRACT

A tubular electric heater (100, 200) is provided with an outer tube (110, 210, 310, 340, 370, 410, 510), with a heat-conducting body (120, 220, 320, 350, 380, 420, 520) and with a tubular electric heating element (130, 230, 330, 360, 390, 430, 530), wherein the tubular electric heater (100, 200) has a continuous groove or opening in the direction in which the tube extends and wherein the heat-conducting body has an opening (122, 222, 322, 352, 382, 522) passing through it in the direction in which the tubular electric heater (100, 200) extends, and the outer tube is supported indirectly or directly on limiting surfaces (123, 124, 223, 224, 323, 353, 383, 423, 523, 524) defining this opening (122, 222, 322, 352, 382, 522) in the heat-conducting body or on an inner tube (140, 440). A method is provided for manufacturing such a tubular electric heater.

### CROSS REFERENCE TO RELATED APPLICATIONS

This application claims the benefit of priority under 35 U.S.C. §119 of German Patent DE 10 2012 109 740.2 filed Oct. 12, 2012, the entire contents of which are incorporated herein by reference.

### FIELD OF THE INVENTION

The present invention pertains to an electric heater having an outer tube, a heat-conducting body and a tubular electric heating element, wherein the tubular electric heater has a continuous groove or opening in the direction in which the tube extends and the present invention pertains to a method for manufacturing such an electric heater.

### BACKGROUND OF THE INVENTION

Such electric heaters are used especially to heat tools, machine parts and devices, especially to heat plastic injection molding nozzles.

There are a number of applications, e.g., in the field of the injection molding of plastics, in which it is very important to obtain a preset, especially uniform temperature distribution on the component to be heated, but this temperature distribution can only be guaranteed if different heat outputs are made available on different sections of the component being heated.

Such an output distribution can be brought about, for example, by selecting as the electric heating element a tubular electric heating element, which is shaped into a three-dimensional curve adapted to the locally desired heat output, so that a larger percentage of the length of the tubular electric heating element and hence a larger percentage of the heat output thereof are arranged in sections in which a higher heat output is needed than in sections in which a lower heat output is needed.

Concretely, a popular solution for the three-dimensional curve for many applications is to shape the tubular electric heating element into coils or meanders, wherein the density of the coils or meanders is selected to be different in different sections, and to bring the tubular electric heating element thus shaped into contact with a heat-conducting body in order to guarantee the desired local homogeneity of the temperature distribution.

It was found in practice that deformation of the three-dimensional curve of the shaped tubular electric heating element, which is very likely to entail a change in the temperature profile obtained over the component to be heated, may occur during the manufacture of an electric heater of this class. It was proposed for this reason, e.g., in EP 1 051 059 B1 that the electric heater consist of a tubular electric heating element and a heat-conducting body with a groove in its outer jacket surface, which presets the desired shape of the tubular electric heating element and with which the tubular electric heating element is pressed. A similar device, in which the groove is provided, however, in the inner jacket surface of the heat-conducting body, is known from EP 1 590 154 B1.

As an alternative to this, it is proposed in DE 10 2010 006 356 A1 that a tubular electric heating element be mounted and fixed in a recess passing through the sheet metal instead of in a groove.

Even though all the above-mentioned solutions avoid deformation of the desired three-dimensional curve, i.e., of the shape of the tubular electric heating element in space, in a relatively reliable manner, they have the drawback that the necessary intimate thermal contact between the tubular electric heating element and the heat-conducting body is not guaranteed with sufficient certainty and sufficiently uniformly and that only low pressing forces can be obtained. This increases the risk of failure, on the one hand, because a locally excessively low heat dissipation from a tubular electric heating element leads to overheating and destruction of said heating element. Even if this does not happen, deviations of the temperature distribution brought about by the electric heater in the space from the desired distribution that is sought to be achieved, which deviations are not acceptable for the desired application, may occur.

### SUMMARY OF THE INVENTION

A basic object of the present invention is thus to make available a tubular electric heater with reduced risk of failure, which electric heater is improved especially in terms of the exact reproducibility of the temperature distribution, which it achieves on a component to be heated, and to propose a method for manufacturing such a tubular electric heater with improved process reliability.

The tubular electric heater according to the present invention has an outer tube, one heat-conducting body and one arranged tubular electric heating element (wherein “one” shall mean “at least one”) and has, furthermore, in the direction in which the outer tube extends, a continuous groove or opening, i.e., a groove or opening that extends in the direction in which the outer tube extends over the entire outer tube.

According to the present invention, the heat-conducting body has an opening or groove passing through it in the direction in which the tubular electric heater extends, and the outer tube is deformed such that a part of its jacket surface meshes with the opening or groove and is supported, at least in some sections, indirectly or directly on the limiting surfaces defining the opening or groove, especially lateral limiting surfaces, or on an inner tube.

The pressing action on the tubular electric heating element can be achieved in an especially simple manner and a very high pressing pressure can be reached due to this support. It is pointed out that the support does not require contact with the entire limiting surface.

A second desirable effect is that the expansion of the heat-conducting body as a consequence of its heating exerts a force on the supported parts of the jacket surface of the outer tube in this embodiment during the operation of the tubular electric heater, which leads to a tensioning action, which improves the press fit on a component to be heated. This effect can be supported especially by selecting the material for the outer tube and heat-conducting body; it increases with the extent to which the coefficient of thermal expansion of the heat-conducting body exceeds the coefficient of thermal expansion of the outer tube.

Supported directly means here that there is a direct contact between the corresponding limiting surfaces of the heat-conducting body defining the opening and the outer tube. The same effect can also be achieved if there is an indirect support, in which the at least one additional layer of a material, especially of an essentially incompressible material, is arranged between these limiting surfaces and the outer tube, e.g., a section of an inner tube that may possibly be provided.

It can also be achieved in this manner, in particular, that the outer tube presses the tubular electric heating element to the heat-conducting body by mechanical prestress.

Good thermal contact is thus guaranteed by the present invention in a reproducible manner between the tubular electric heating element and the heat-conducting body without deformation of the tubular electric heating element being needed. In addition, fixing of the outer tube, especially against twisting on the heat-conducting body, can be achieved, and it is possible to achieve accuracy of fit of the individual components of the electric heater in relation to one another, to increase a gap-free contact of the outer tube, and to achieve clearance-free seating. In particular, the outer tube can be placed without clearance and with accurate fit on desired sites of the heat-conducting body and/or tubular heating element.

Moreover, the that fact the outer tube is provided has per se further favorable effects, for example, a protective function for the heat-conducting body and the tubular electric heating element and, if the material is selected properly, reflection and concentration of the heat radiated by the tubular electric heating element at first in the direction of the outer tube onto the component to be heated.

The word “tubular” in the sense of this patent specification is defined such that the electric heater surrounds at least almost completely an interior space, into which a component to be heated can be inserted. Just as the tube walls define an interior space in a water pipe, so do sections or components of the tubular electric heater in the electric heater, and just as the direction in which a water pipe extends defines the direction in which the water can be transported, the direction in which the component to be heated can be inserted is likewise defined in the same manner in the tubular electric heater. The surface extending at right angles to the direction of extension at a given site is a cross-sectional area, which is extensively enclosed by sections or components of the electric heater. Explicitly included and even preferred is, however, the possibility that a tubular electric heater has an opening passing through it in the direction in which it extends, i.e., it is designed like a tube slotted along the direction in which it extends. It is also pointed out additionally that the cross section does not necessarily need to be round, but may have any desired shape.

Different boundary surfaces of a tubular electric heater are correspondingly defined as well. “Inside” is the direction facing the interior space, into which the component to be heated can be pushed. “Outside” is the direction opposite “inside.” When viewed in a given direction at right angles to the direction of extension, the outer tube is correspondingly always located at a greater distance from the interior space than the heat-conducting body, while an inner tube that may possibly be provided is always arranged closer to the interior space than the heat-conducting body when viewed in a given direction at right angles to the direction of extension. Front surfaces are the cross-sectional areas that are at right angles to the direction of extension at the ends of the tubular electric heater.

The heat-conducting body is a body consisting of a heat-conducting material, e.g., brass or copper, which ensures that the heat generated by the tubular electric heating element is distributed locally, so that heat is introduced into the component to be heated not only locally at sites at which the tubular electric heating element is arranged, but also in the area surrounding these sites.

Despite this local homogenization of the introduction of heat onto a component to be heated by the heat-conducting body at a given site of the tubular electric heater, the amount of heat introduced to a component to be heated can be varied over the entire tubular electric heater by the three-dimensional curve, which describes the tubular electric heating element, being correspondingly adapted. For example, the tubular electric heating element may be coiled, providing a great coil pitch at sites at which a low heat output is to be provided and a low coil pitch at other sites.

The exact position of the three-dimensional curve is of crucial significance for a number of applications, especially in case of small overall size, and it is therefore fixed in an advantageous embodiment by at least one positioning means. For example, a groove in the heat-conducting body, into which the tubular electric heating element is inserted, but also rods, webs or comb structures arranged on the heat-conducting body or on a metal jacket, around which the tubular electric heating element is wound, may be used as a positioning means.

It is especially advantageous if the tubular electric heating element is fixed by positioning means provided on the heat-conducting body, e.g., a groove or guide sections, because, contrary to, for example, the outer tube, this tubular electric heating element does not have to be subjected to any deformation for providing a prestress. The terminals of the tubular heating element may exit from the electric heater, depending on the requirements of the application, e.g., on the front side or in the middle, doing so radially, axially or even tangentially.

It is especially advantageous if the heat-conducting body is a body worked, especially milled from a solid material or tube. Not only is such working from solid material possible in a cost-effective manner with modern machining techniques even if positioning devices of a complicated shape are arranged on it, but it also provides a massive and hard-to-deform heat-conducting body. This is very valuable especially when the prestress of the outer tube shall be achieved by support on the limiting surfaces defining the opening passing through the heat-conducting body in the direction of extension, because a higher stress is possible now. Heat-conducting bodies that are manufactured by rolling up a flat sheet metal with tubular electric heating element inserted into grooves are markedly less suitable for this.

However, the heat-conducting body may also be a body composed of a plurality of pieces, where the plurality of pieces may consist of the same material or different materials.

It is advantageous in respect to the reduction of heat losses if a heat insulator is arranged between the heat-conducting body and the outer tube at least in some sections. This may also be a powder or granular material strewn in in case of a suitable design of the electric heater.

In an advantageous variant of the present invention, the tubular electric heater also has an inner tube. This is not only important for creating a closed space if a powder or granular material shall be strewn as a heat insulator or to improve the heat condition between the tubular electric heating element and the heat-conducting body, but it can also solve another problem, because common materials for heat-conducting bodies, especially brass or copper, tend to adhere to the component to be heated after a longer operating time. This can be prevented by an inner tube made of a suitable material, especially stainless steel.

It is, moreover, helpful for applications in which a powder or granular material is used if the outer tube and the inner tube have at least one common contact line or contact surface, at which they are connected to one another. The connection may be performed, e.g., by welding, soldering or mechanically, especially by, e.g., by forming.

It is, furthermore, advantageous in the same case of application if the outer tube and the inner tube are connected to one another on at least on one front side of the tubular electric heater by an end plate. The connection may be performed, e.g., by welding, soldering or mechanically, especially by, e.g., pressing or crimping, in this case as well.

The method according to the present invention for manufacturing a tubular electric heater with the above-mentioned advantages has the following steps, which, unless mentioned otherwise, should advantageously be performed in this order, but not necessarily obligatorily immediately one after another.
a) Providing an outer tube, a tubular electric heating element and a heat-conducting body with an opening passing completely through the heat-conducting body in the direction in which the heat-conducting body extends. It is especially preferred here if the heat-conducting body has a positioning device and/or is worked out of a massive piece of material.
b) Shaping of the tubular electric heating element such that this follows a desired three-dimensional curve. If a positioning means is provided, this is preferably performed on the heat-conducting body by insertion into the positioning means.
c) Pushing of the outer tube over the heat-conducting body with the tubular electric heating element inserted between the heat-conducting body and the outer tube.
d) Forming of the outer tube, so that it meshes by part of its tube jacket with the opening passing completely through the heat-conducting body in the direction in which said heat-conducting body extends, as a result of which a groove is formed in the outer tube. It shall be noted in connection with this step that it is also possible, in principle, to provide an outer tube already formed in this manner. However, since this forming step can also contribute to a mechanical stress of the outer tube, forming at this point of the process is to be preferred.
e) Inserting at least one shaped part into the groove and radial pressing of the arrangement on a calibrating mandrel.
f) Removing the at least one shaped part.

Especially step e) is considered to be essential for the present invention. The shaped part inserted ensures during the radial pressing that the outer tube will be stressed onto the heat-conducting body without a gap and with accurate fit and it provides as a result the necessary pressing pressure for securing the intimate thermal contact between the tubular electric heating element and the heat-conducting body. In particular, it is thus also possible to introduce such strong forces during pressing that not only the outer tube, but also the geometry of the heat-conducting body will be deformed.

Further process steps may be optionally performed, e.g., an inner tube may also be inserted into the heat-conducting body before step d) and the outer tube and the inner tube are slotted and/or connected to one another. An end plate may also be formed integrally in one piece with the outer tube or between the outer tube and an inner tube that may possibly be present, and this end plate can then be formed and can increase the mechanical prestress attained.

It is also possible to provide different shaped parts in some sections, which will then lead to a groove with varying cross section, into which, e.g., a thermocouple can be inserted.

In another advantageous variant of the manufacturing process, such a high pressure is used during pressing that the heat-conducting body will become deformed. Especially high mechanical prestresses can be achieved as a result on the outer tube.

The present invention will be explained in more detail below on the basis of figures, which show exemplary embodiments of the present invention. In the drawings, The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1a is an exploded view of a first exemplary embodiment;

FIG. 1b is a variant of the exemplary embodiment according to FIG. 1a with a continuous opening;

FIG. 1c is a cross-sectional view of the variant of the exemplary embodiment from FIG. 1a shown in FIG. 1b;

FIG. 2a is a view of a second exemplary embodiment during manufacture, before the outer jacket is pushed over;

FIG. 2b is a view of the finished tubular electric heater according to the second exemplary embodiment, wherein a part of the outer jacket is not shown;

FIG. 3a is a detail view of a first variant of the relative arrangement of the outer jacket, heat-conducting body and tubular electric heating element in relation to one another;

FIG. 3b is a detail view of a second variant of the relative arrangement of the outer jacket, heat-conducting body and tubular electric heating element in relation to one another;

FIG. 3c is a detail view of a third variant of the relative arrangement of the outer jacket, heat-conducting body and tubular electric heating element in relation to one another;

FIG. 3d is a detail view of a fourth variant of the relative arrangement of the outer jacket, heat-conducting body and tubular electric heating element in relation to one another;

FIG. 4a is a detail view of a first possibility for supporting the outer tube;

FIG. 4b is a detail view of a second possibility for supporting the outer tube;

FIG. 4c is a detail view of a third possibility for supporting the outer tube;

FIG. 4d is a detail view of a fourth possibility for supporting the outer tube;

FIG. 4e is a detail view of a fifth possibility for supporting the outer tube;

FIG. 4f is a detail view of a sixth possibility for supporting the outer tube;

FIG. 4g is a detail view of a seventh possibility for supporting the outer tube;

FIG. 4h is a detail view of an eighth possibility for supporting the outer tube;

FIG. 5a is a detail view of the area in which the outer tube is supported before pressing during the manufacture of a tubular electric heater;

FIG. 5b is a detail view of the area in which the outer tube is supported after pressing during the manufacture of a tubular electric heater;

FIG. 6a is an arrangement comprising an outer tube and heat-conducting body before compression;

FIG. 6b is the arrangement from FIG. 6a after compression with a shaped part with a first geometry;

FIG. 6c is the arrangement from FIG. 6a after compression with a shaped part with a second geometry;

FIG. 7a is a first intermediate stage during the manufacture of an electric heater; and

FIG. 7b is a second intermediate stage during the manufacture of an electric heater, which stage results from the intermediate stage according to FIG. 7a by pressing.

### DESCRIPTION OF THE PREFERRED EMBODIMENTS

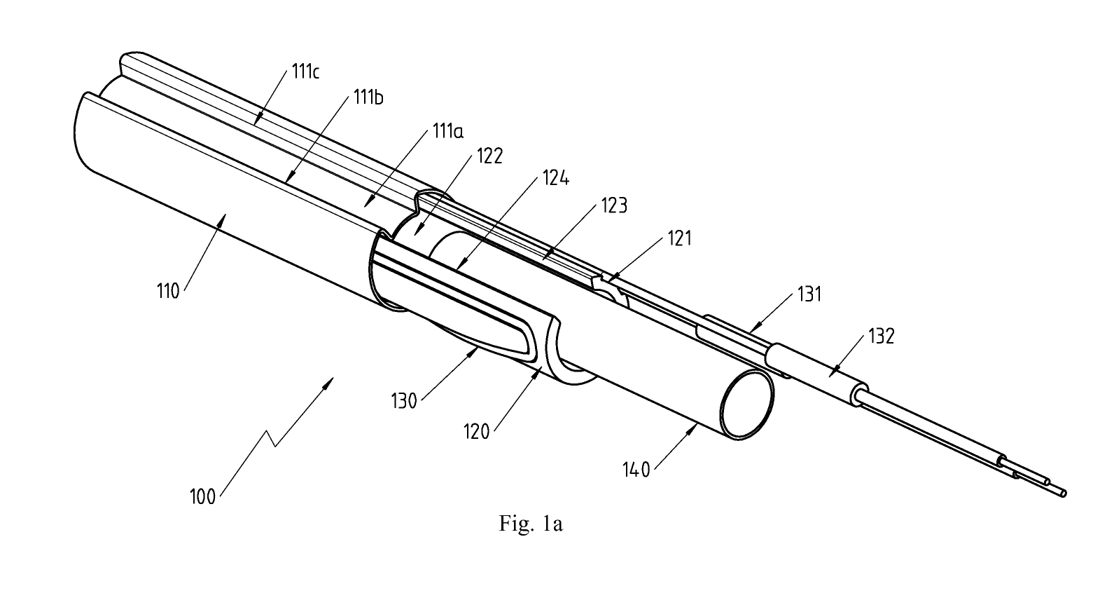

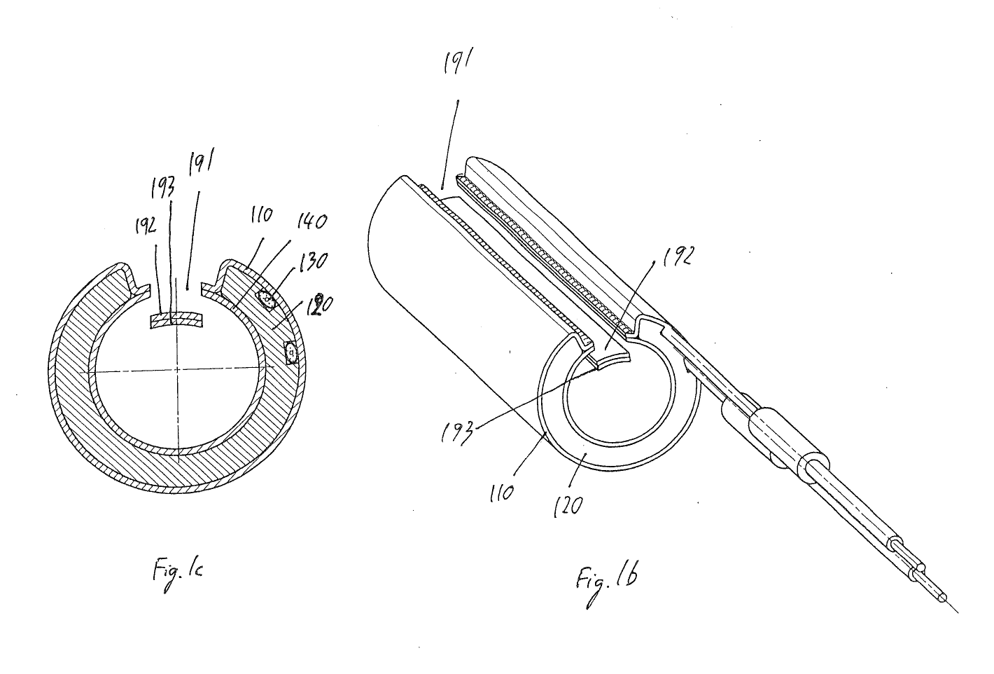

Referring to the drawings in particular, FIG. 1a shows an exploded view of a first exemplary embodiment for a tubular electric heater 100. The assembly units 110, heat-conducting body 120, tubular electric heating element 130 and inner tube 140, which are arranged one inside the other in reality and are pressed to one another, are shown in the exploded view telescopically shifted relative to one another in the direction in which the cylindrically shaped tubular electric heater extends.

As can be determined from FIG. 1a, the heat-conducting body 120 is arranged around the inner tube 140. The heat-conducting body 120 has an opening 122, which passes through it in the direction in which the tubular electric heater 100 extends and is defined by the limiting surfaces 123, 124. In addition, a positioning device 121 in the form of a meandering groove is provided on the heat-conducting body.

The course of the positioning device 121 in space presets the three-dimensional curve, which the tubular electric heating element 130, which is inserted into the positioning device 121 and can be supplied with current via the terminals 131, 132, assumes, and secures the tubular electric heating element 130 against deformation.

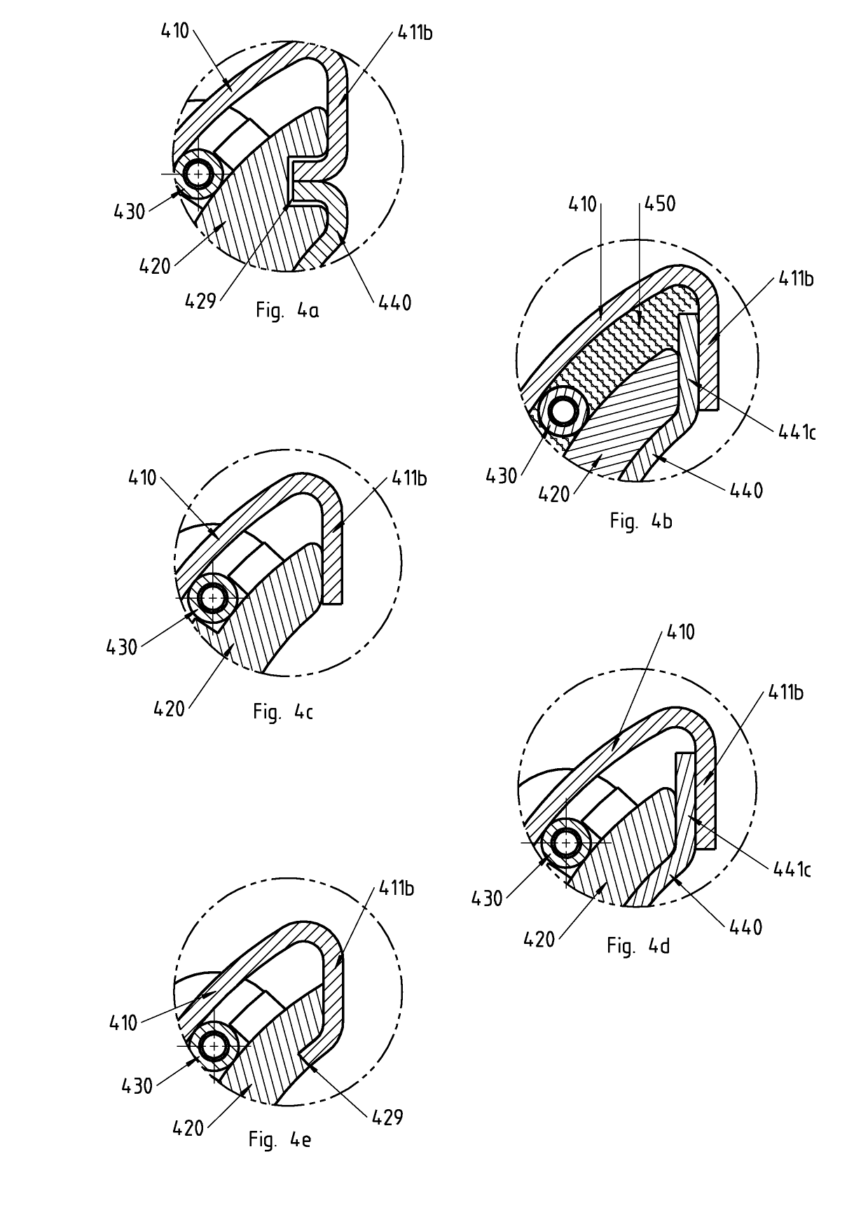

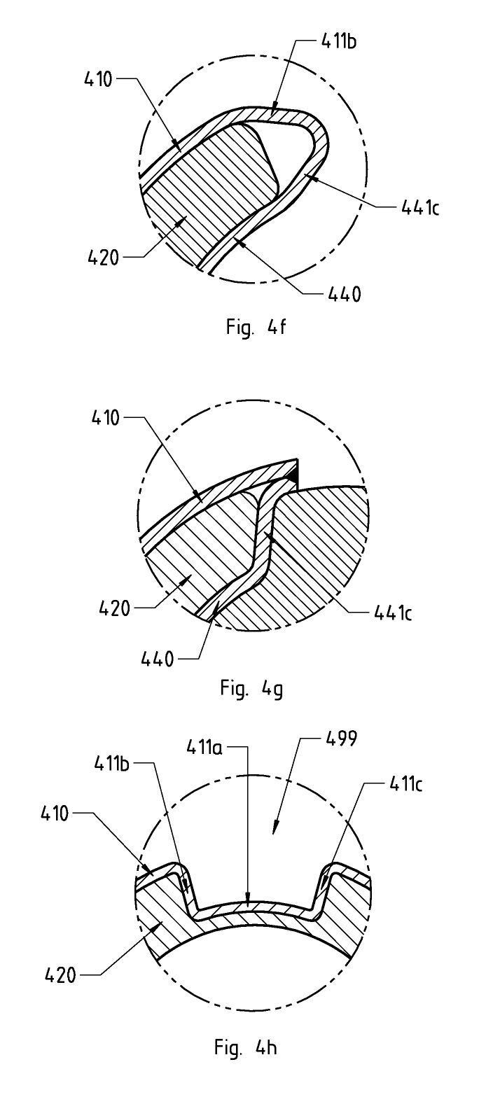

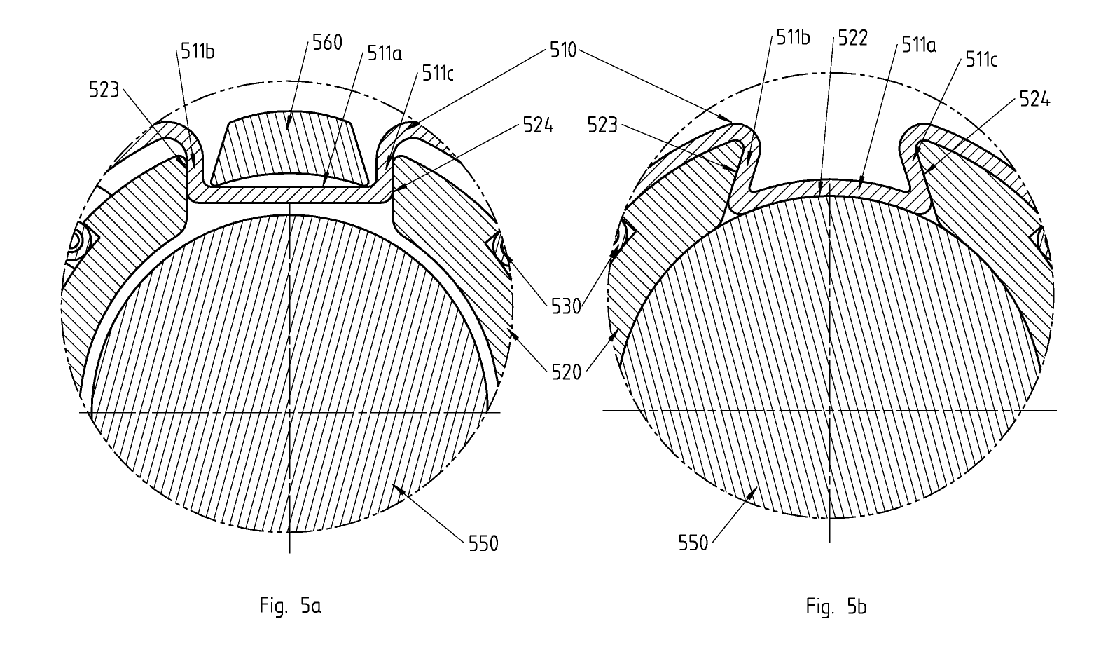

The firm and intimate contact of the tubular heating element 130 with the positioning device 121, more precisely with the ground and possibly wall surfaces of the groove, in the form of which the positioning device 121 is designed, is guaranteed by the outer tube 110. The outer tube 110 is deformed such that the part of its jacket surface formed by the sections 111a, 111b and 111c meshes with the opening 122 passing through the heat-conducting body 120 in the direction in which it extends, wherein section 111b is supported at the limiting surface 124 defining the opening 122 in the heat-conducting body 120 and section 111c is supported at the limiting surface 123 defining the opening 122 in the heat-conducting body 120. This support leads to a mechanical prestress on the outer tube 110, which ensures the intimate thermal contact between the tubular electric heating element 130 and the heat-conducting body 120 and guarantees clearance-free and accurately fitting seating of the outer tube 110. Details of the support will be described below on the basis of FIGS. 4a through 4g.

As is shown in FIGS. 1b and 1c, a variant of the electric heater 100, in which a continuous opening 191 is prepared instead of a continuous groove 190, can be manufactured from the electric heater 100 shown in FIG. 1a by cutting out a section 192 of the outer tube 110 and a section 193 of the inner tube 140, especially together, in the area of groove 190. Direct access can thus be made possible to a component heated by the electric heater 100, which may be advantageous, e.g., for a direct temperature measurement on that component. The respective cut-out sections 192, 193 are still contained in the views according to FIGS. 1b and 1c in order to demonstrate the corresponding process step during the manufacture more clearly, but they are, of course, subsequently removed in practice.

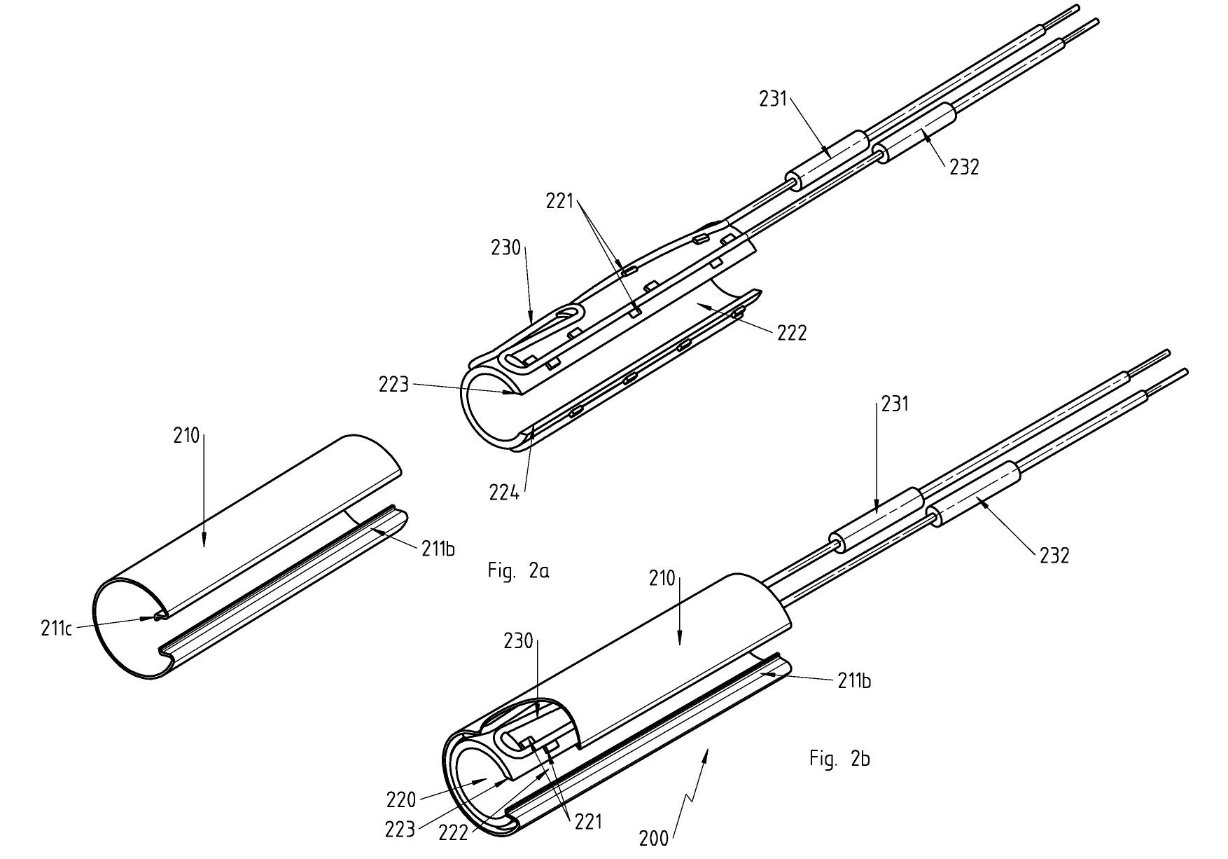

FIGS. 2a and 2b pertain to a second exemplary embodiment of the present invention with outer tube 210, heat-conducting body 220 and tubular electric heating element 230, where FIG. 2b shows the finished tubular electric heater 200 and FIG. 2a an intermediate stage during the manufacture thereof.

As can be recognized especially in FIG. 2a, the heat-conducting body 230 has an opening 222, which passes through it in the direction in which the tubular electric heater 200 extends and is defined by the limiting surfaces 223, 224. In addition, a positioning device 221 in the form of a plurality of positioning sections is provided on the heat-conducting body, and said positioning device presets the three-dimensional curve, which the tubular electric heating element 230, which is inserted into the positioning device 221 and can be supplied with current via the terminals 231, 232, assumes, and secures the tubular electric heating element 230 against deformation. As is apparent from FIG. 2a, this is a three-dimensional curve in this case, which has meanders at one end of the tubular electric heater 200 but not at the other end.

Different quantities of heat are correspondingly made available during the operation of the electric heater and a component to be heated, e.g., an injection nozzle for plastics, and consequently also heated at different intensities. The closer the individual meanders are located in relation to one another, the higher is the temperature that can be reached. It is, of course, also possible to use coils with different coil pitch instead of meanders.

The firm and intimate contact of the tubular heating element 230 with the positioning device 221 is guaranteed, as can be best recognized in FIG. 2b, by the outer tube 210. The outer tube 210 or its tube jacket has, according to FIG. 2a, sections 211b, 211c bent in the direction of the central axis of outer tube 210. They mesh, as can be seen in FIG. 2b, with the opening 222 passing through the heat-conducting body 220 in the direction in which it extends, and section 211b is supported on the limiting surface 224 defining the opening 222 in the heat-conducting body 220 and section 211c is supported on the limiting surface 223 defining the opening 122 in the heat-conducting body 220. This support leads to the generation of a mechanical prestress on outer tube 210, which ensures the intimate thermal contact between the tubular electric heating element 230 and the heat-conducting body 220 and guarantees accurately fitting, clearance-free seating of the outer tube 210. Details of the support will be described below on the basis of FIGS. 4a through 4g.

The differences between the embodiments according to FIG. 1, on the one hand, and FIGS. 2a, 2b, on the other hand, are that the tubular electric heater 200 has no inner tube, that the positioning devices 122, 222 are designed as a groove milled in the heat-conducting body 120 in one case and as positioning sections cut out of the heat-conducting body 220 in the other case, and that only the sections 211b, 211c of the tube jacket mesh in the outer tube 210 with the opening 222 passing through the heat-conducting body 220 in the direction in which it extends, which said sections can be prepared by forming a slotted tube or by removing the bottom of a depression formed in the tube. The tubular electric heater 200 thus has an opening that is continuous in the direction in which the tube extends, but the tubular electric heater 100 has a groove that is continuous in the direction in which the tube extends.

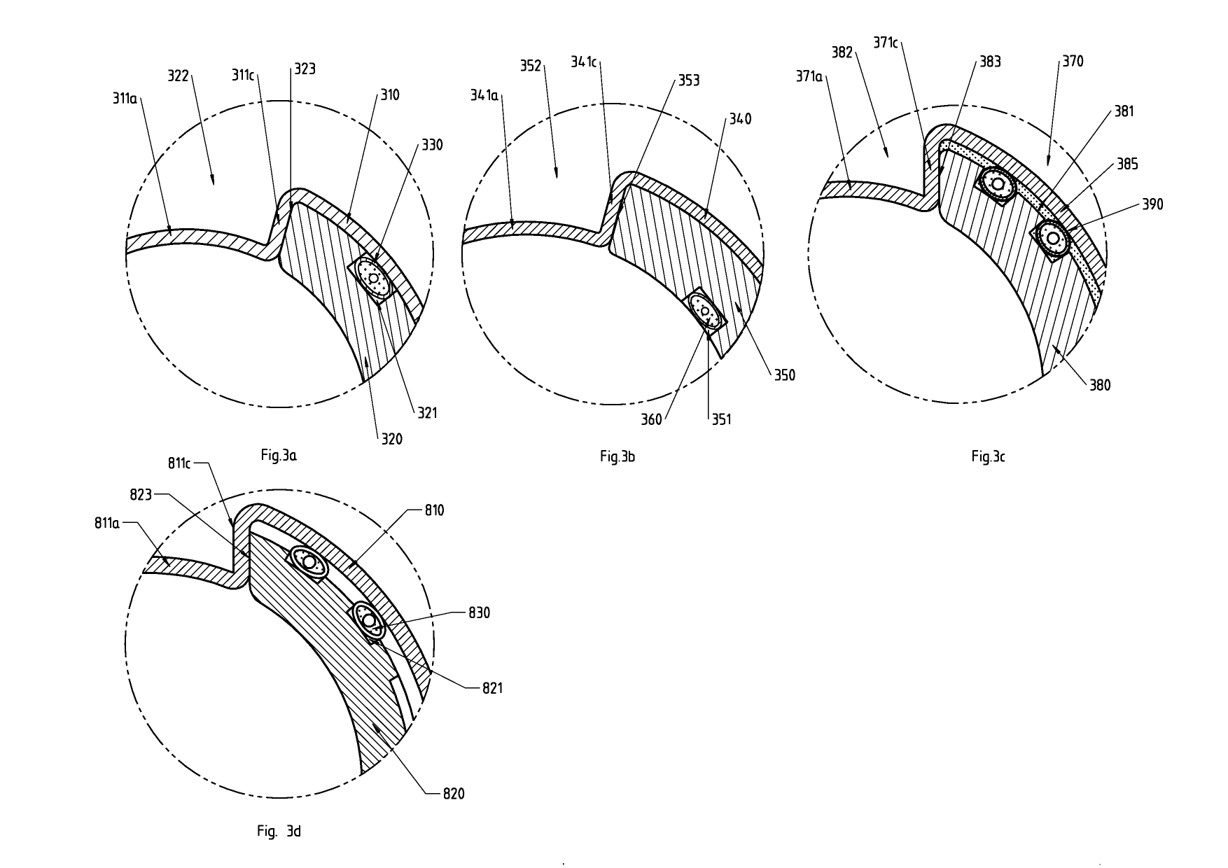

Relative different arrangements of the outer tube 310, 340, 370, 810, heat-conducting body 320, 350, 380, 820 and tubular electric heating element 330, 360, 390, 830 in relation to one another shall now be explained on the basis of FIGS. 3a through 3d. These figures show each a partial area of a cross section through a tubular electric heater according to the present invention in the boundary area to the opening 322, 352, 382, 822, which passes through the heat-conducting body 320, 350, 380, 820 in the direction in which said heat-conducting body extends and with which mesh the respective partial sections 311a, 311c; 341a, 341c, 371a, 371c and 811a, 811c of the jacket of the outer tube 310, 340, 370, 810, wherein the partial sections 311c, 341c, 371c, 811c are supported on the respective surface 323, 353, 383, 823 of the heat-conducting body 320, 350, 380, 820, which said surface defines the opening 322, 352, 382, 822 on the side shown.

In the embodiment according to FIG. 3a, the positioning device 321 is a groove and the tubular electric heating element is arranged between outer tube 310 and heat-conducting body 320.

As an alternative to this, it is also possible, as is shown in FIG. 3b, to arrange the positioning device 351, presented again as a groove, at the surface of the heat-conducting body facing the component to be heated.

Another alternative embodiment is shown in FIG. 3c, in which not only is the positioning device 381 embodied by positioning sections arranged on the heat-conducting body 380, but there also remains a cavity, which is not recognizable because it is filled with a heat insulator 385, especially in the form of a compacted powder or granular material, which transmits the pressure of the outer tube 370 mechanically prestressed by the support and thus establishes the desired intimate thermal contact between the tubular electric heating element 390 and the heat-conducting body 380.

The embodiment according to FIG. 3d largely corresponds to the embodiment according to FIG. 3c, but it does not contain any insulator. A cavity 885 remains, instead.

It should be noted that the well-known inner structure of the tubular electric heating element with the resistance wire extending in its center, the metal jacket defining its circumference and the electrical insulator arranged between the resistance wire and the metal jacket of the tubular electric heating element can also be recognized in the sectional views as shown in, e.g., FIGS. 3a through 3d. All these embodiments are, of course, also possible if an inner tube is provided.

FIGS. 4a through 4f shows in detail different possibilities of how the support of the outer tube can be embodied. An outer tube 410, a heat-conducting body 420 and a tubular electric heating element 430 are recognized in all these figures, always shown only partially. Moreover, a part of an inner tube 440 can also be recognized in FIGS. 4a, 4b and 4d.

A section 411b each of the jacket of the outer tube 410 meshes in the heat-conducting body 420 with the opening passing through the heat-conducting body 420 in the direction in which the latter extends in the variants according to FIGS. 4a through 4e. It is supported directly at the heat-conducting body 420 in FIGS. 4a, 4c and 4e, whereas it is supported indirectly via a section 441b of the jacket of the inner tube in FIGS. 4a and 4d.

If, as is shown in the variants according to FIGS. 4a and 4e, section 411b of the jacket of the outer tube 410 meshes with a recess or groove 429 of the heat-conducting body 420, an especially high mechanical prestress can be achieved.

The outer tube 410 is not supported either indirectly or directly at the heat-conducting body 420 in the variant according to FIG. 4f, but it is supported at the inner tube 440 via the section 411b meshing with the opening passing through the heat-conducting body 420 in the direction in which the latter extends. Similarly to what is seen in FIG. 4b, an intermediate space, which may be filled, e.g., with a heat insulator 450, will correspondingly remain in this area between the heat-conducting body 420 and the outer tube 410.

In the variant according to FIG. 4g, the outer tube 410 is connected, e.g., welded, as is indicated by the weld seam represented as a black triangle, to a section 441b of the jacket of the inner tube 440, which meshes with the opening passing through the heat-conducting body 420 in the direction in which the latter extends and is supported at the heat-conducting body 420. The mechanical prestressing of the outer tube 410 is brought about in this manner here.

The variant according to FIG. 4h illustrates that support of the outer tube 410 is also possible if only a groove 499 passes through the heat-conducting body 420 in the direction in which the latter extends.

It shall still be explained by means of FIGS. 5a and 5b how the desired mechanical prestressing of the outer tube is brought about in the method according to the present invention. The detail view of a cross section through a tubular electric heater according to FIG. 5a shows the outer tube 510, heat-conducting body 520 and tubular electric heating element 530. Sections 511a, 511b, 511c of the jacket of the outer tube 510, which form a depression 519, mesh with the opening 522 passing through the heat-conducting body 520 in the direction in which the latter extends. However, the individual components are only placed on one another on a calibrating mandrel 550 so far and are not pressed together. However, a shaped part 560 is already inserted into the depression 519 for preparation for pressing.

As can be recognized in FIG. 5b, which shows the same view after pressing and removal of the shaped part 560, the heat-conducting body 520 has been deformed by the pressing, but this is not absolutely necessary. It is already sufficient in many cases for a deformation of the sections 511a, 511b and 511c, which mechanically stresses the part of the outer tube 510 surrounding the heat-conducting body 520, to have taken place due to the pressing in the presence of the shaped part.

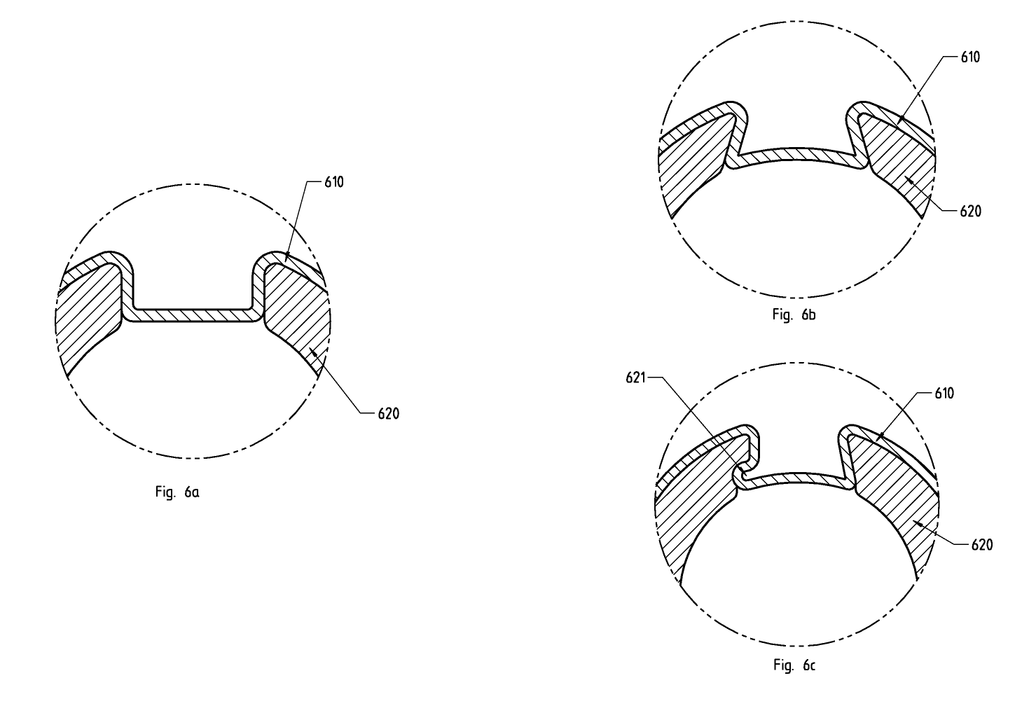

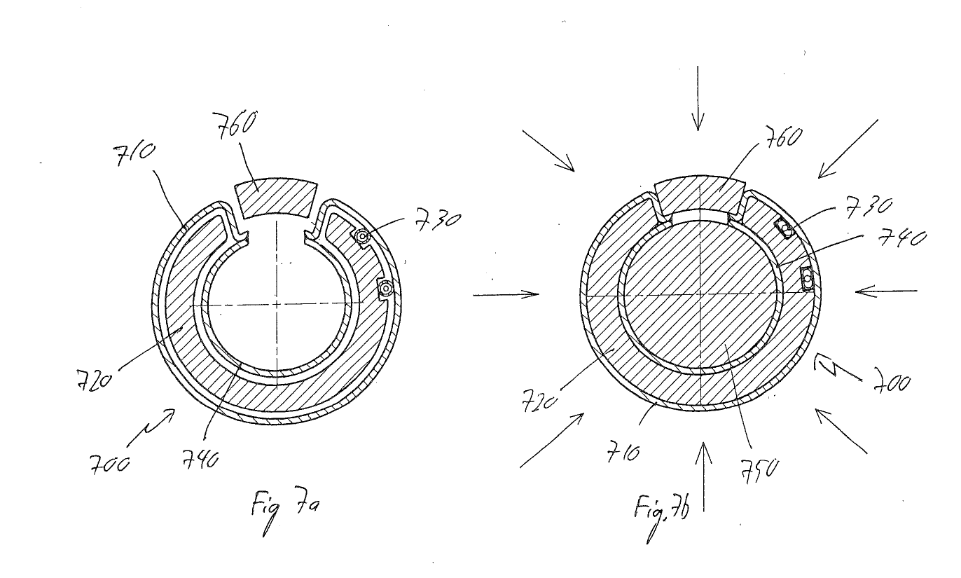

The great variability of embodiments that can be obtained due to the use of different shaped parts shall be illustrated once again on the basis of FIGS. 6a through 6c. FIG. 6a shows an arrangement comprising the outer tube 610 and the heat-conducting body 620 before compression. If a wedge-shaped shaped part is used during pressing, the arrangement shown in FIG. 6b is obtained after compression. For example, as is shown in FIG. 6c, a recess 621 for a thermocouple can be prepared in a simple and practical manner by the use of another shaped part during compression.

While FIG. 1b showed a first possibility of preparing a tubular electric heater according to the present invention with an opening passing through same along the direction in which the tube extends, it is also possible, as an alternative to this, to prepare an electric heater 700, in which a slotted outer tube 710 and a slotted inner tube 740 are used, besides the slotted heat-conducting body 720 and the tubular heating element 730, and are pressed radially in the same manner as explained in connection with FIGS. 5a, b as well as 6a through 6c, this possibility being shown in FIG. 7a, which shows the state before the radial pressing in the presence of a shaped part 760, and in FIG. 7b, which shows the state after pressing in the presence of the shaped part 760 on a mandrel 750.

The features of the embodiments described above can be freely combined with one another unless this leads to conflicts. In particular, the different embodiments of the inner jacket, heat-conducting body, positioning device and outer tube explained above can be freely combined with one another.

While specific embodiments of the invention have been shown and described in detail to illustrate the application of the principles of the invention, it will be understood that the invention may be embodied otherwise without departing from such principles.

### APPENDIX

### List of Reference Numbers

100, 200 Tubular electric heater
110, 210, 310, 340,
370, 410, 510, 610,
810 Outer tube
111a, 111b, 111c,
211b, 211c, 311a,
311c, 341a, 341c,
371a, 371c, 411b,
511a, 511b, 511c,
811a, 811b, 811c Sections of the jacket of the outer tube
120, 220, 320, 350,
380, 420, 520, 620,
820 Heat-conducting body
121, 221, 321, 351,
381 Positioning device
122, 222, 322, 352,
382, 522 Opening
123, 124, 223, 224,
323, 353, 383, 423,
523, 524, 823 Limiting surface
130, 230, 330, 360,
390, 430, 530 Tubular electric heating element
131, 132, 231, 232 Terminals
140, 440 Inner tube
885 Cavity
429 Groove
450, 885 Heat insulator
499 Groove
519 Depression
550 Calibrating mandrel
560 Shaped part

What is claimed is:

1. A tubular electric heater comprising:
an outer tube;
a heat-conducting body; and
a tubular electric heating element, wherein:
the tubular electric heater has a continuous groove or opening in a direction in which the tube extends;
the heat-conducting body has an opening or groove passing through the heat-conducting body in the direction in which the tubular electric heater extends and has limiting surfaces defining said opening or groove; and
the outer tube is supported at least in some sections indirectly or directly on the limiting surfaces.

2. A tubular electric heater in accordance with claim 1, wherein the outer tube is deformed such that a part of a jacket surface of the outer tube meshes with the opening passing through the heat-conducting body in the direction in which the heat-conducting body extends and the outer tube is supported at least in some sections on the limiting surfaces defining said opening in the heat-conducting body.

3. A tubular electric heater in accordance with claim 1, further comprising positioning devices provided on the heat-conducting body, wherein the tubular electric heating element is fixed at least in some sections by the positioning devices.

4. A tubular electric heater in accordance with claim 1, wherein the heat-conducting body is cut out of a solid material or tube.

5. A tubular electric heater in accordance with claim 1, wherein the heat-conducting body is a body composed of a plurality of pieces formed of one of the same material and different materials.

6. A tubular electric heater in accordance with claim 1, further comprising a heat insulator arranged at least in some sections between the heat-conducting body and the outer tube.

7. A tubular electric heater in accordance with claim 1, wherein the tubular electric heater has an inner tube.

8. A tubular electric heater in accordance with claim 7, wherein the outer tube and the inner tube have at least one common contact line or contact surface, at which the outer tube and the inner tube are connected to one another.

9. A tubular electric heater in accordance with claim 7, further comprising an end plate on at least one front side of the tubular electric heater, wherein the outer tube and the inner tube are connected to one another by the end plate.

10. A tubular electric heater in accordance with claim 7, wherein the outer tube and the inner tube are crimped together on at least one front side of the tubular electric heater.

11. A method for manufacturing a tubular electric heater, the method comprising the steps of:
providing an outer tube, a tubular electric heating element and a heat-conducting body with an opening passing completely through the heat-conducting body in a direction in which the heat-conducting body extends;
shaping of the tubular electric heating element such that the tubular electric heating element follows a desired three-dimensional curve;
pushing the outer tube over the heat-conducting body with the tubular electric heating element inserted between the heat-conducting body and the outer tube;
forming of the outer tube such that the outer tube meshes with a part of a tube jacket surface, with the opening passing completely through the heat-conducting body in the direction in which the latter extends and a groove is formed as a result in the outer tube;
inserting a shaped part into the groove to form an arrangement and radially pressing of the arrangement on a calibrating mandrel; and
removing the shaped part.

12. A method in accordance with claim 11, further comprising providing positioning devices on the heat-conducting body, wherein the tubular electric heating element is fixed at least in some sections by the positioning devices.

13. A method in accordance with claim 11, wherein the heat-conducting body is cut out of a solid material or tube.

14. A method in accordance with claim 11, wherein the heat-conducting body is a body composed of a plurality of pieces formed of one of the same material and different materials.

15. A method in accordance with claim 11, further comprising providing a heat insulator arranged at least in some sections between the heat-conducting body and the outer tube.

16. A method in accordance with claim 11, wherein the tubular electric heater has an inner tube.

17. A method in accordance with claim 16, wherein the outer tube and the inner tube have at least one common contact line or contact surface, at which the outer tube and the inner tube are connected to one another.

18. A method in accordance with claim 17, further comprising providing an end plate on at least one front side of the tubular electric heater, wherein the outer tube and the inner tube are connected to one another by the end plate.

19. A method in accordance with claim 17, wherein the outer tube and the inner tube are crimped together on at least one front side of the tubular electric heater.

20. A tubular electric heater comprising:
an outer tube defining a continuous groove or opening in a direction in which the outer tube extends;
a heat-conducting body having an opening or groove passing through the heat conducting body in the direction in which the tubular electric heater extends, the opening or groove of the heat-conducting body having limiting surfaces the outer tube being supported at least in some sections indirectly or directly on the limiting surfaces; and
a tubular electric heating element shaped such that the tubular electric heating element follows a desired three-dimensional curve, the outer tube being pushed over the heat-conducting body with the tubular electric heating element inserted between the heat-conducting body and the outer tube.
